(19) United States
(12) Patent Application Publication
(10) Pub. No.: US 2009/0059715 A1
(43) Pub. Date: Mar. 5, 2009

(54) PASTRY BLENDER

(76) Inventors: Lynn Vendl, Woodridge, IL (US); Louis Henry, Scarsdale, NY (US); Melanie Conklin, Brooklyn, NY (US); Charles Paradise, New York, NY (US)

Correspondence Address: PATENT GROUP;C/O DLA PIPER US LLP, 203 N. LASALLE ST., SUITE 1900, CHICAGO, IL, 60601, US

(21) Appl. No.: 12/169,353

(22) Filed: Jul. 8, 2008

Related U.S. Application Data
(60) Provisional application No. 60/959,041, filed on Jul. 10, 2007.

(51) Int. Cl. B01F 13/00

(52) U.S. Cl. 366/129

(57) ABSTRACT

A pastry blender that includes a handle, a plurality of arcuate cutting wires attached to the handle, and a plurality of arcuate blending wires that are also attached to the handle. The pastry blender can also include a scraper that removably connects to the cutting wires and the blending wires.

### RELATED APPLICATIONS

This application claims the benefit of U.S. Provisional Patent Application Ser. No. 60/959,041, filed on Jul. 10, 2007, currently pending. The disclosure of which is hereby incorporated by reference in its entirety.

### BACKGROUND

This disclosure generally relates to kitchen utensils, and more particularly to a pastry blender, also known as a pastry cutter.

Pastry dough generally has a flaky or crumbly texture. A good pastry is light and airy. When making pastry dough, care must be taken to blend the fat, such as shortening or butter, and flour thoroughly before adding any liquid. This ensures that the flour granules are adequately coated with fat and are less likely to develop gluten. On the other hand, over-mixing results in long gluten strands that tend to toughen the pastry.

Pastry blenders are primarily used to cut fat into the flour, as well as to blend the two together, in the process of making pastry dough. It is desirable for pastry blenders to cut through the fat because the fat is typically added in cold chunks to the flour. It is also desirable for pastry blenders, once the fat has been cut, to be able to blend the fat and flour into a uniform, granular consistency.

Different types of pastry blenders have different advantages and disadvantages. A blade type blender, for example, is very good at cutting through cold fat, but tends to blend the fat poorly due to the large spacing between the blades. A wire type blender, however, is very good at blending the fat into the flour, but does not cut the fat as well as a blade type blender because the wires tend to splay out around cold chunks of fat instead of cutting through.

With the use of either type of pastry blender, fat and flour often stick to the blender during its use, particularly to the inside surface of the blades or wires. Build up of fat and flour on the blades or wires decreases the effectiveness of the cutting and blending process. Accordingly, use of a pastry blender is typically stopped several times during the cutting and blending process in order to clean the blades or wires. Generally, cleaning of the blades or wires can be accomplished by the use of a spatula, a knife, or clean fingers.

### BRIEF SUMMARY

This disclosure relates to pastry blenders of the type that are often utilized in blending flour and fat to make pastry dough, as well as to scrapers that can be utilized with such pastry blenders.

In one aspect, a pastry blender is provided that includes a handle, a plurality of arcuate cutting wires attached to the handle, and a plurality of arcuate blending wires that are also attached to the handle. The handle has a grip, a first wire receiving end, and a second wire receiving end. Each cutting wire having a cutting wire thickness, a first end received by the first receiving end of the handle, an apex, and a second end received by the second receiving end of the handle. Each blending wire also has a first end received by the first receiving end of the handle, an apex, and a second end received by the second receiving end of the handle, as well as a blending wire thickness that is less than the cutting wire thickness. The cutting wires and blending wires can be attached to the handle in a row or line, and can be arranged so that at least one cutting wire is attached to the handle adjacent to at least one blending wire. The pastry blender can also include a scraper that removably connects to the cutting wires and the blending wires.

In another aspect, a scraper that removably connects to a pastry blender is provided that includes a wire retaining end and a locking end attached to the wire retaining end. The wire retaining end slidably engages a pastry blender. For example, the wire retaining end can have at least one ridge or at least one slot that slidably engages the cutting wires and the blending wires. The locking end has a locked position and an unlocked position. For example, the locking end can have a first locking half and a second locking half that removably connects to the first locking half to lock the scraper onto the pastry blender.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 is a perspective view of one example of a pastry blender.

FIG. 2 is a perspective view of the pastry blender of FIG. 1, with a scraper attached thereto in a locked position.

FIG. 3 is a perspective view of the pastry blender of FIG. 2, with the scraper in an unlocked position.

FIG. 4 is a perspective view of the scraper of FIGS. 2 and 3.

### DETAILED DESCRIPTION

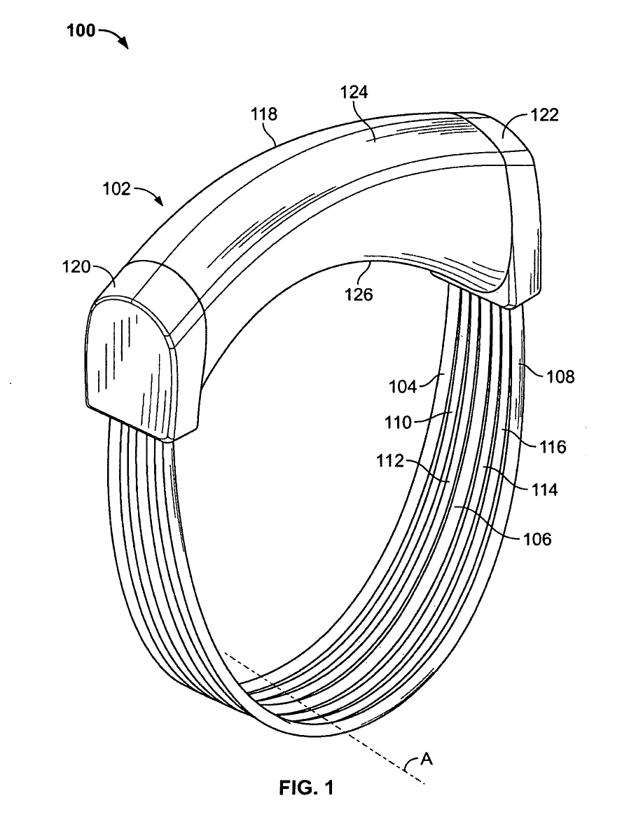

One example of a pastry blender is illustrated in FIG. 1. Pastry blender 100 has a handle 102, cutting wires 104, 106, and 108, and blending wires 110, 112, 114 and 116.

The handle 102 has a grip 118, a first wire receiving end 120, a second wire receiving end 122. Grip 118 has a top surface 124 and a bottom surface 126. The grip 118 is preferably ergonomic in shape and dimension, such that the grip fits comfortably in the hand of a user. A user would preferably hold grip 118 by placing the user's palm on top surface 124 and wrapping the user's fingers downwards around bottom surface 126. The grip 118 of handle 102 can be made of any suitable material, including but not limited to wood, plastic, stainless steel, rubber, or a combination thereof. Grip 118 can be solid or hollow, and can also be a single piece or multiple pieces. For example, grip 118 can have a wood or stainless steel core and a rubber cover or coating. The first and second wire receiving ends 120 and 122 can also be made of any suitable material, although the are preferably made of stainless steel.

The pastry blender 100 has a plurality of cutting wires and a plurality of blending wires. The blending wires and the cutting wires are all preferably made of stainless steel, although they can be made from any suitable material, such as, for example, a food grade metal or plastic. The cutting wires are thick wires, and have a cutting wire thickness that is suitable for cutting through fat, such as butter or shortening. The cutting wires are preferably rigid or semi-rigid. The cutting wires can exhibit some degree of flexibility or movement during use. It is preferred, however, that the cutting wires not shift significantly during use in order to facilitate their ability to cut through fat, particularly cold, usually refrigerated, pieces of fat, which tend to be hard as compared to softened fat at room temperature or warmer. The blending wires are thin wires that blend the pastry dough to an appropriate consistency. The blending wires have a blending wire thickness that is less than the cutting wire thickness. The blending wires are preferably flexible or semi-flexible, and can shift or splay during use, such as when contacted with cold fat. Although not being bound by any particular theory, it is believed that the use of cutting wires and blending wires in combination allows the pastry blender to provide improved results at both cutting fat into flour, and blending the fat and flour together.

As illustrated in FIG. 1, the pastry blender has three cutting wires 104, 106 and 108, and four blending wires 110, 112, 114, and 116. Alternatively, the pastry blender can have at least two cutting wires, or at least three cutting wires. The pastry blender can also have at least two blending wires, at least three blending wires, or at least four blending wires. The cutting wires 104, 106 and 108, and the blending wires 110, 112, 114, and 116 are attached to the handle in a row or line. The cutting wires and blending wires can be arranged in any suitable manner. Preferably, the cutting wires and blending wires are arranged so that at least one cutting wire is attached to the handle adjacent to, or next to, at least one blending wire. For example, the cutting wires and blending wires can be arranged so that each blending wire is adjacent to at least one cutting wire. The cutting wires and blending wires can also be arranged so that each blending wire is adjacent to one cutting wire and one blending wire. In the illustrated example, the cutting wires 104, 106 and 108, and the blending wires 110, 112, 114, and 116 are arranged so that each blending wire is adjacent to, one cutting wire and one blending wire. The order of the wires as shown is cutting wire 104, blending wire 110, blending wire 112, cutting wire 106, blending wire 114, blending wire 1116, and then cutting wire 108.

Each cutting wire and each blending wire has a first end and a second end. The first and second ends of the cutting and blending wires are received and retained by the first wire receiving end 120 of the handle 102 and the second wire receiving end 122 of the handle 102, respectively. The cutting and blending wires are preferably permanently mounted or attached to the handle 102 within the first and second wire receiving ends 120 and 122 according to any suitable method known in the art. Each cutting wire can be the same length as any other cutting wire, or can be a different length. Similarly, each blending wire can be the same length as any other blending wire, or can be a different length. Further, each cutting wire can be the same length as any blending wire, or can be a different length. Each cutting wire has a cross section that can be, but is not limited to, a circle, a square, a triangle, an n-gon, or an irregular shape. Similarly, blending wire has a cross section that can be, but is not limited to, a circle, a square, a triangle; an n-gon, or an irregular shape.

The blending wires and cutting wires each extend downwardly from the handle 102 in an arcuate manner. Each cutting wire and each blending wire is thus arcuate, and the arc of each cutting wire and each blending wire has an apex. The apex of each arcuate cutting wire and the apex of each arcuate blending wire can be substantially coplanar, which would appear as a line in cross section. For example, the apex of each cutting wire 104, 106, and 108, and the apex of each blending wire 110, 112, 114 and 116 can be substantially coplanar, at line A in FIG. 1. Alternatively, the apex of each cutting wire and each blending wire can form an arc, which would appear as a curve in cross section at line A. The blending wires and cutting wires can be arranged so that they are adjacent and touching, or adjacent with a narrow space, at their first end and at their second end, and so that they are spaced apart at their apex. The space between the apex of any cutting wire and the apex of an adjacent blending wire is preferably greater that the space between an end of the cutting wire and the corresponding end of the adjacent blending wire. Similarly, the space between the apex of any blending wire and the apex of an adjacent blending wire is preferably greater that the space between an end of the blending wire and the corresponding end of the adjacent blending wire.

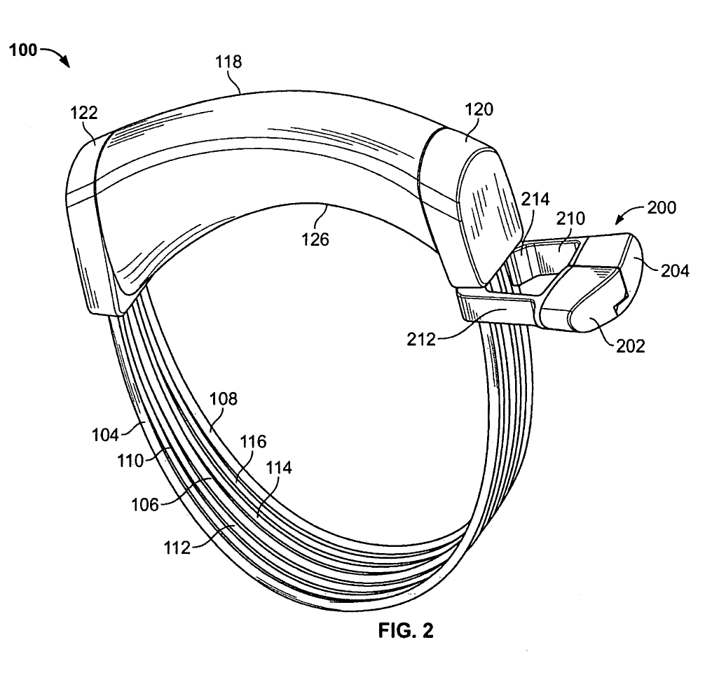

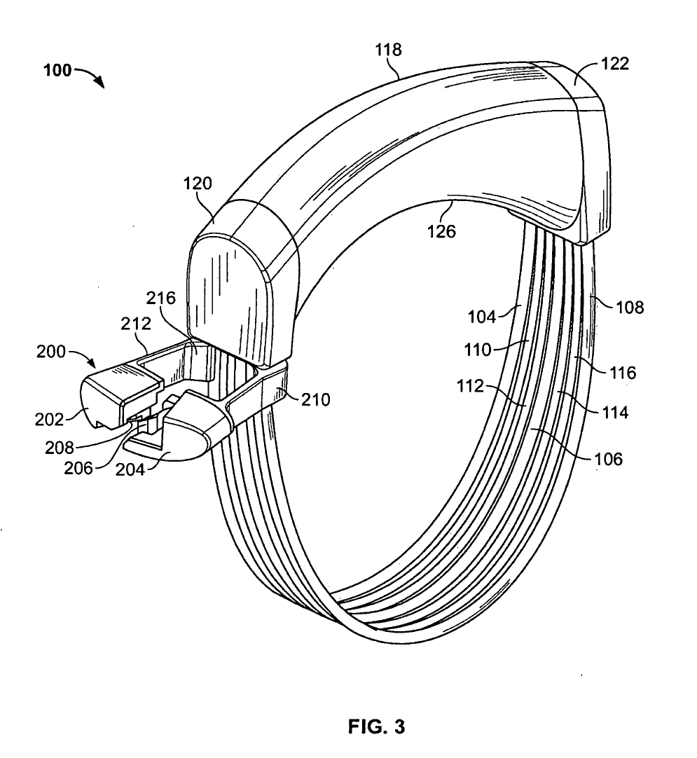

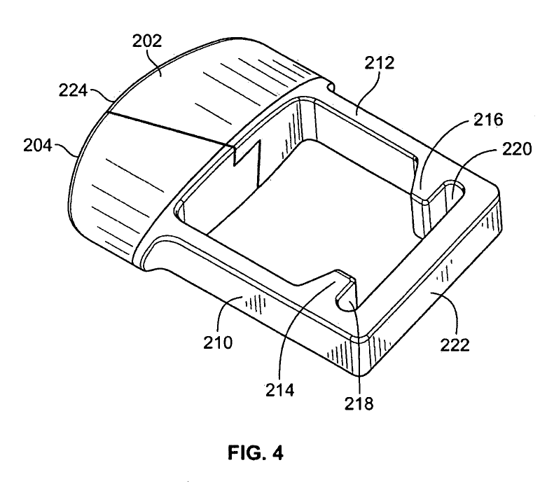

In some examples, pastry blenders also have a scraper that slidably engages the pastry blender. A scraper can allow pastry blender users to scrape off dough or fat that has gotten caught on the pastry blender wires. FIGS. 2 and 3 illustrate a scraper 200 that is on the pastry blender 100. FIG. 4 illustrates scraper 200 by itself, removed from pastry blender 100. Scraper 200 has a wire retaining end 222 and a locking end 224. Locking end 224 is attached to the wire retaining end 222 by first side 210 and second side 212.

As shown in FIGS. 2 and 3, scraper 200 removably connects to the cutting wires and the blending wires of pastry blender 100. The locking end 224 has a locked position, shown in FIG. 2, and an unlocked position, shown in FIG. 3. For example, the locking end can have a first locking half 202 and a second locking half 204 that removably connects to the first locking half 202. In such examples, when the two locking halves 202 and 204 are connected, the locking end 224 is in the locked position, and when the two locking halves 202 and 204 are unconnected, the locking end 224 is in the unlocked position. In practice, the two locking halves 202 and 204 can be disconnected, the scraper 200 can be placed onto the wires of the pastry blender 100, and the two locking halves 202 and 204 can be connected to lock the locking end 224, thus connecting scraper 200 to pastry blender 100. To remove the scraper 200, the two locking halves 202 and 204 can be disconnected to unlock the locking end 224, and the scraper 200 can be removed from the pastry blender 100.

The two locking halves can connect in any suitable manner, such as, for example, an interlocking fit, a friction fit, or a press fit. As illustrated in FIG. 3, first locking half 202 has a first fastener half 208 that receives second fastener half 206 on second locking half 204. First fastener half 208 can be a groove or recess, and second fastener half 206 can be a tab or protrusion that is received by the groove or recess of first fastener half 208. Alternatively, first fastener half 208 can be a first tab or protrusion, and second fastener half can be a second tab or protrusion that interlocks with the first tab or protrusion of first fastener half 208. Other examples of fasteners include, but are not limited to a hook and loop, a snap, and a ball and socket.

Referring to FIGS. 2 through 4, the wire retaining end 222 of the scraper 200 slidably engages the pastry blender 100. More specifically, the wire retaining end 222 the slidably engages the cutting wires and the blending wires of pastry blender 100. For example, the wire retaining end 222 can have at least one ridge or at least one slot that slidably engages the cutting wires and the blending wires of the pastry blender 100. As shown in FIG. 4, the wire retaining end 222 has a first ridge 214 on the first side 210 of the scraper 200, and a second ridge 216 on the second side 212 of the scraper 200. A first slot or space 218 is located between the inner wall of the wire retaining end 222 and the first ridge 214. A second slot or space 220 is located between the inner wall of the wire retaining end 222 and the second ridge 216. The first and second slots 218 and 220 have a slot width that can be equal to or greater than the cutting wire width of cutting wires 104 and 108. The slot width can be measured from the inside wall of the wire retaining end 222 to either first ridge 214 or second ridge 216. Alternatively, a scraper 200 could not have any ridges, and at least one slot could be formed as a recess, such as a notch or groove, in one or both of the sides 210 and 212 of the scraper 200.

In practice, the cutting wires and blending wires tend to get coated in flour and fat when the pastry blender 100 is in use. When the scraper 200 is connected to the pastry blender 100, a user can grip the locking end 224 of the scraper and exert a force to slide the wire retaining end 222 along the arc of the wires from the first end of the wires to the second end, and back, if desired. The inside wall of the wire retaining end 222 abuts, and preferably closely abuts, the wires of the pastry blender, which can contact and dislodge flour, fat, or combinations thereof, from the wires of the pastry blender as the scraper 200 slides along the wires. The first and second sides 210 and 212 preferably have a length that protrudes away from the wires of the pastry blender, so that locking end 224 is spaced away from the wires. Such spacing can facilitate the ability of any dislodged fat or flour to fall away from the pastry blender. After use, the scraper 200 can be removed from the pastry blender 200, and each can be cleaned.

The wire retaining end 222 preferably has a shape that facilitates the removal of flour, fat, and combinations thereof from the wires of a pastry blender. For example, the wire retaining end 222 can have a cross sectional shape that is a square, a rectangle, a semi circle, a triangle, an n-gon, or any other suitable shape. The inner wall of the wire retaining end 222 can have a width that is wider than the width of the first and second legs 210 and 212 of the scraper 200. Additionally, the wire retaining end 222, and particularly the inner wall thereof, can be smooth or textured. Further, the wire retaining end 222 can include a ramped or inclined scraping edge.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A pastry blender comprising:
a handle having a grip, a first wire receiving end, and a second wire receiving end;
a plurality of arcuate cutting wires attached to the handle, each cutting wire having a cutting wire thickness, a first end received by the first receiving end of the handle, an apex, and a second end received by the second receiving end of the handle; and
a plurality of arcuate blending wires attached to the handle, each blending, wire having a blending wire thickness that is less than the cutting wire thickness, a first end received by the first receiving end of the handle, an apex, and a second end received by the second receiving end of the handle;
wherein at least one cutting wire is attached to the handle adjacent to at least one blending wire.

2. The pastry blender of claim 1, wherein the pastry blender comprises at least two cutting wires.

3. The pastry blender of claim 1, wherein the pastry blender comprises at least two cutting wires.

4. The pastry blender of claim 1, wherein the pastry blender comprises at least three cutting wires.

5. The pastry blender of claim 1, wherein the pastry blender comprises at least four blending wires.

6. The pastry blender of claim 1, wherein the apex of each arcuate cutting wire and the apex of each arcuate blending wire are substantially coplanar.

7. The pastry blender of claim 1, wherein each blending wire is adjacent to at least one cutting wire.

8. The pastry blender of claim 1, wherein each blending wire is adjacent to one cutting wire and one blending wire.

9. The pastry blender of claim 1, wherein each blending wire is adjacent to one cutting wire and one blending wire.

10. The pastry blender of claim 1, further comprising a scraper that removably connects to the cutting wires and the blending wires.

11. The pastry blender of claim 10, wherein the scraper comprises:
a wire retaining end; and
a locking end attached to the wire retaining end, the locking end having a locked position and an unlocked position.

12. The pastry blender of claim 11, wherein the wire retaining end comprises at least one ridge or at least one slot that slidably engages the cutting wires and the blending wires.

13. The pastry blender of claim 11, wherein the locking end comprises a first locking half and a second locking half that removably connects to the first locking half.

14. A pastry blender comprising:
a handle having a grip, a first wire receiving end, and a second wire receiving end;
a plurality of arcuate cutting wires attached to the handle, each cutting wire having a cutting wire thickness, a first end received by the first receiving end of the handle, an apex, and a second end received by the second receiving end of the handle;
a plurality of arcuate blending wires attached to the handle, each blending wire having a blending wire thickness that is less than the cutting wire thickness, a first end received by the first receiving end of the handle, an apex, and a second end received by the second receiving end of the handle; and
a scraper that removably connects to the cutting wires and the blending wires.

15. The pastry blender of claim 14, wherein the scraper comprises:
a wire retaining end; and
a locking end attached to the wire retaining end, the locking end having a locked position and an unlocked position.

16. The pastry blender of claim 15, wherein the wire retaining end comprises at least one ridge or at least one slot that slidably engages the cutting wires and the blending wires.

17. The pastry blender of claim 15, wherein the locking end comprises a first locking half and a second locking half that removably connects to the first locking half.

18. The pastry blender of claim 15, wherein each blending wire is adjacent to one cutting wire and one blending wire.

19. A scraper that removably connects to a pastry blender, the scraper comprising:
a wire retaining end that slidably engages a pastry blender; and
a locking end attached to the wire retaining end, the locking end having a locked position and an unlocked position.

20. The pastry blender of claim 19, wherein the wire retaining end comprises at least one ridge or at least one slot that slidably engages the cutting wires and the blending wires, and the locking end comprises a first locking half and a second locking half that removably connects to the first locking half.
